(19) United States
(12) Patent Application Publication
(10) Pub. No.: US 2011/0181601 A1
(43) Pub. Date: Jul. 28, 2011

(54) CAPTURING VIEWS AND MOVEMENTS OF ACTORS PERFORMING WITHIN GENERATED SCENES

(75) Inventors: Michael Mumbauer, San Diego, CA (US); David Murrant, Carlsbad, CA (US)

(73) Assignee: SONY COMPUTER ENTERTAINMENT AMERICA INC., Foster City, CA (US)

(21) Appl. No.: 12/692,518

(22) Filed: Jan. 22, 2010

(51) Int. Cl. G06T 15/70; G06K 9/00

(52) U.S. Cl. 345/473; 382/103

(57) ABSTRACT

Generating scenes for virtual environment of a visual entertainment program, comprising: capturing views and movements of an actor performing within the generated scenes, comprising: tracking movements of a headset camera and a plurality of motion capture markers worn by the actor within a physical volume of space; translating the movements of the headset camera into head movements of a virtual character operating within the virtual environment; translating the movements of the plurality of motion capture markers into body movements of the virtual character; generating first person point-of-view shots using the head and body movements of the virtual character; and providing the generated first person point-of-view shots to the headset camera worn by the actor.

### CROSS-REFERENCE TO RELATED APPLICATIONS

This application is related to co-pending U.S. patent application Ser. No. 12/419,880, filed Apr. 7, 2009, and entitled “Simulating Performance of Virtual Camera.” The disclosure of the above-referenced application is incorporated herein by reference.

### BACKGROUND

1. Field of the Invention

The present invention relates to motion pictures and video games, and more specifically, to simulating performance of a virtual camera operating inside scenes generated for such motion pictures and video games.

2. Background

Motion capture systems are used to capture the movement of real objects and map them onto computer generated objects. Such systems are often used in the production of motion pictures and video games for creating a digital representation that is used as source data to create a computer graphics (CG) animation. In a session using a typical motion capture system, an actor wears a suit having markers attached at various locations (e.g., having small reflective markers attached to the body and limbs) and digital cameras record the movement of the actor. The system then analyzes the images to determine the locations (e.g., as spatial coordinates) and orientations of the markers on the actor's suit in each frame. By tracking the locations of the markers, the system creates a spatial representation of the markers over time and builds a digital representation of the actor in motion. The motion is then applied to a digital model, which may then be textured and rendered to produce a complete CG representation of the actor and/or performance. This technique has been used by special effects companies to produce realistic animations in many popular movies and games.

### SUMMARY

The present invention provides for generating scenes for virtual environment of a visual entertainment program.

In one implementation, a method for capturing views and movements of an actor performing within the generated scenes is disclosed. The method includes: tracking movements of a headset camera and a plurality of motion capture markers worn by the actor within a physical volume of space; translating the movements of the headset camera into head movements of a virtual character operating within the virtual environment; translating the movements of the plurality of motion capture markers into body movements of the virtual character; generating first person point-of-view shots using the head and body movements of the virtual character; and providing the generated first person point-of-view shots to the headset camera worn by the actor.

In another implementation, a method of capturing views and movements of an actor performing within generated scenes is disclosed. The method includes: tracking positions and orientations of an object worn on a head of the actor within a physical volume of space; tracking positions of motion capture markers worn on a body of the actor within a physical volume of space; translating the positions and orientations of the object into head movements of a virtual character operating within virtual environment; translating the positions of the plurality of motion capture markers into body movements of the virtual character; and generating first person point-of-view shots using the head and body movements of the virtual character.

In another implementation, a system of generating scenes for virtual environment of a visual entertainment program is disclosed. The system includes: a plurality of position trackers configured to track positions of a headset camera object and a plurality of motion capture markers worn by an actor performing within a physical volume of space; an orientation tracker configured to track orientations of the headset camera object; a processor including a storage medium storing a computer program comprising executable instructions that cause the processor to: receive a video file including virtual environment; receive tracking information about the positions of the headset camera object and the plurality of motion capture markers from the plurality of position trackers; receive tracking information about the orientations of the headset camera object from the orientation tracker; translate the positions and the orientations of the headset camera object into head movements of a virtual character operating within the virtual environment; translate the positions of the plurality of motion capture markers into body movements of the virtual character; generate first person point-of-view shots using the head and body movements of the virtual character; and provide the generated first person point-of-view shots to the headset camera object worn, by the actor.

In a further implementation, a computer-readable storage medium storing a computer program for generating scenes for virtual environment of a visual entertainment program is disclosed. The computer program includes executable instructions that cause a computer to: receive a video file including virtual environment; receive tracking information about the positions of the headset camera object and the plurality of motion capture markers from the plurality of position trackers; receive tracking information about the orientations of the headset camera object from the orientation tracker; translate the positions and the orientations of the headset camera object into head movements of a virtual character operating within the virtual environment; translate the positions of the plurality of motion capture markers into body movements of the virtual character; generate first person point-of-view shots using the head and body movements of the virtual character; and provide the generated first person point-of-view shots to the headset camera object worn by the actor.

Other features and advantages of the present invention will become more readily apparent to those of ordinary skill in the art after reviewing the following detailed description and accompanying drawings.

### BRIEF DESCRIPTION OF THE DRAWINGS

FIG. 1 shows one example scene in which virtual characters are shown in an intermediate stage of completion.

FIG. 2 shows one example scene in which life-like to features are added onto the virtual characters in an intermediate stage shown in FIG. 1.

FIG. 3 is one example scene showing a first person point-of-view shot.

FIG. 4 shows one example of several different configurations of a motion capture session.

FIG. 5 shows a physical volume of space for tracking a headset camera and markers worn by an actor operating within scenes generated for motion pictures and/or video games.

FIG. 6 shows one example of an actor wearing a headset camera and a body suit with multiple motion capture markers attached to the suit.

FIG. 7 shows one example setup of a physical volume of space for performing motion capture sessions.

FIG. 8 shows one example of a headset camera, which uses a combination of hardware and software to capture the head movement of an actor.

FIG. 9 is a flowchart illustrating a process for capturing views and movements of an actor performing within scenes generated for motion pictures, video games, and/or simulations.

### DETAILED DESCRIPTION

Certain implementations as disclosed herein provide for capturing views and movements of an actor performing within scenes generated for motion pictures, video games, simulations and/or other visual entertainment programs. In some implementations, the views and movements of more than one actor performing within the generated scenes are captured. Other implementations provide for simulating the performance of a headset camera operating within the generated scenes. The generated scenes are provided to the actor to assist the actor to perform within the scenes. In some implementations, the actor includes a performer, a game player, and/or a user of a system that generates motion pictures, video games, and/or other simulations.

In one implementation, the generated scenes are provided to a headset camera worn by an actor to provide a feel of virtual environment to the actor. The actor wearing the headset camera physically moves about a motion capture volume, wherein the physical movement of the headset is tracked and translated into a field of view of the actor within the virtual environment.

In some implementations, this field of view of the actor is represented as point-of-view shots of a shooting camera. In a further implementation, the actor wearing the headset may also be wearing a body suit with a set of motion capture markers. Physical movements of the motion capture markers are tracked and translated into movements of the actor within the virtual environment. The captured movements of the actor and the headset are incorporated into the generated scenes to produce a series of first person point-of-view shots of the actor operating within the virtual environment. The first person point-of-view shots fed back to the headset camera allow the actor to see the hands and feet of the character operating within the virtual environment. The above-described steps are particularly useful for games where first person perspectives are frequently desired as a way of combining story telling with an immersive game play.

In one implementation, the virtual environment in which the virtual character is operating comprises virtual environment generated for a video game. In another implementation, the virtual environment in which the virtual character is operating comprises hybrid environment generated for a motion picture in which virtual scenes are integrated with live action scenes.

It should be noted that the headset camera is not a physical camera but a physical object that represents a virtual camera in virtual environment. Movements (orientation changes) of the physical object are tracked to correlate them with the camera angle point-of-view of the virtual character operating within the virtual environment.

In the above-described implementations, the first person point-of-view shots are captured by: tracking the position and orientation of the headset worn by the actor; and translating the position and orientation into the field of view of the actor within the virtual environment. Moreover, the markers disposed on the body suit worn by the actor are tracked to generate the movements of the actor operating within the virtual environment.

After reading this description it will become apparent how to implement the invention in various implementations and applications. However, although various implementations of the present invention will be described herein, it is understood that these implementations are presented by way of example only, and not limitation. As such, this detailed description of various implementations to should not be construed to limit the scope or breadth of the present invention.

With the advent of technology that provides more realistic and life-like animation (often in 3-D environment), video games are becoming more interactive entertainment rather than just games. Further, the interactivity can be incorporated into other entertainment programs such as motion pictures or various types of simulations. Motion capture sessions use a series of motion capture cameras to capture markers on the bodies of actors, translate the captured markers into a computer, apply them onto skeletons to generate graphical characters, and add life-like features onto the graphical characters.

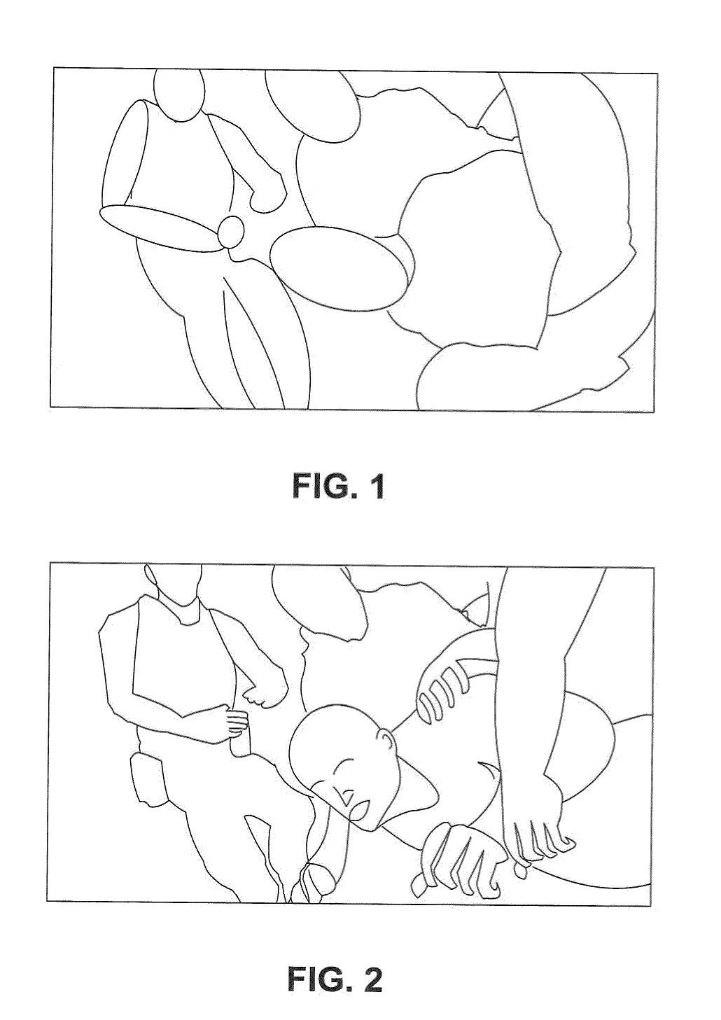

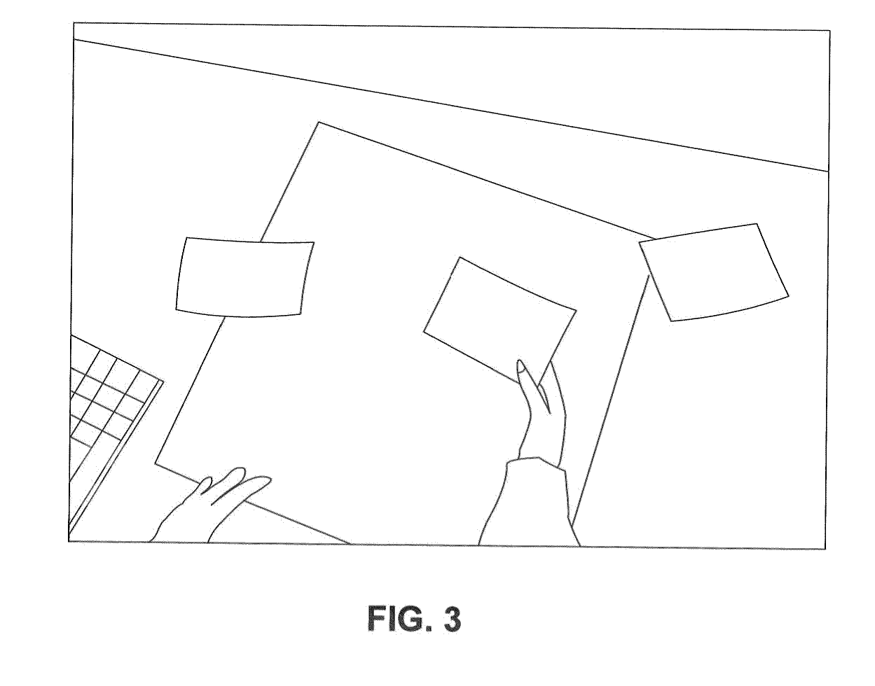

For example, FIGS. 1 and 2 show life-like features (see FIG. 2) added onto the graphical characters (see FIG. 1) using a motion capture session. Further, simulating the first person point-of-view shots of an actor (e.g., as shown in FIG. 3) performing inside the scenes generated for a video game allows the players of the video game to get immersed in the game environment by staying involved in the story.

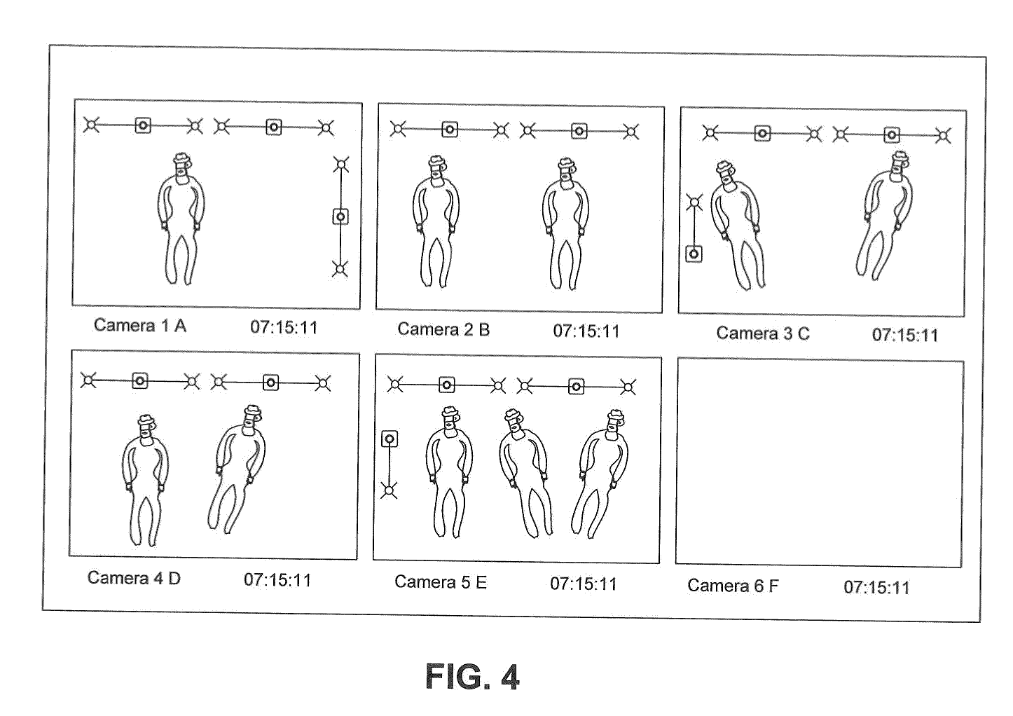

The generated scenes in the 3-D environment are initially captured with film cameras and/or motion capture cameras, processed, and delivered to the physical video camera. FIG. 4 shows one example of several different configurations of a motion capture session. In an alternative implementation, the scenes are generated by computer graphics (e.g., using keyframe animation).

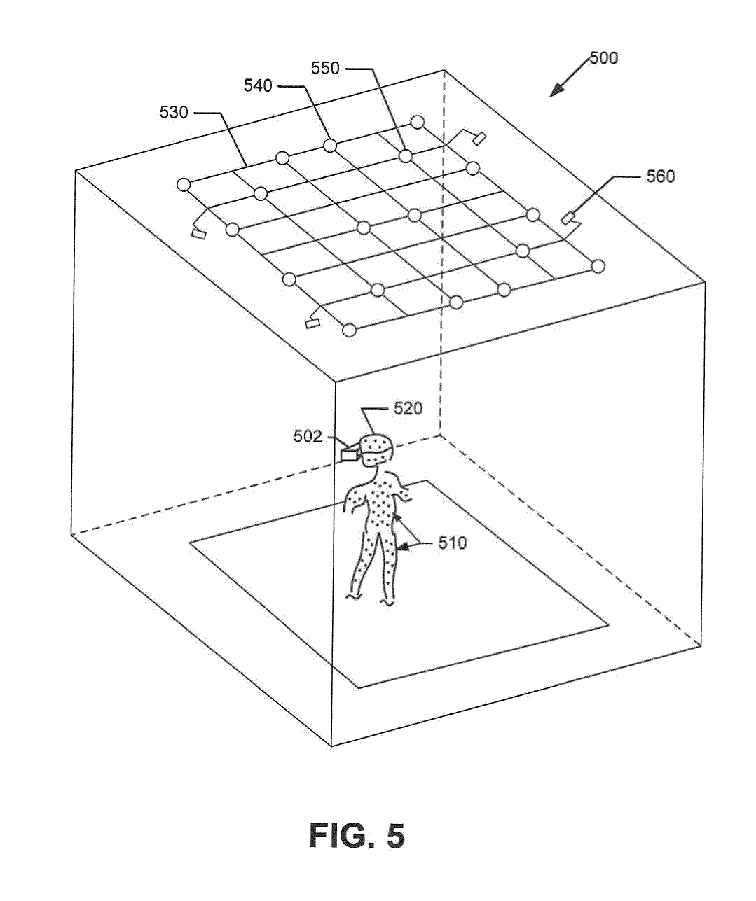

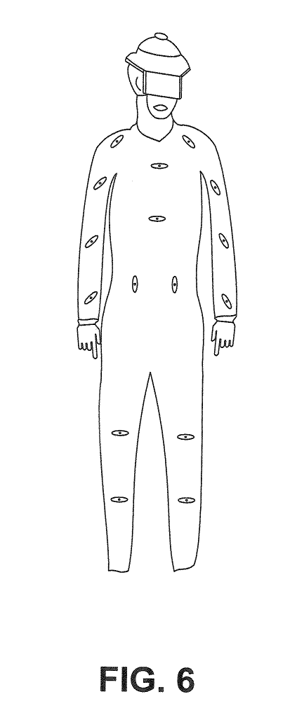

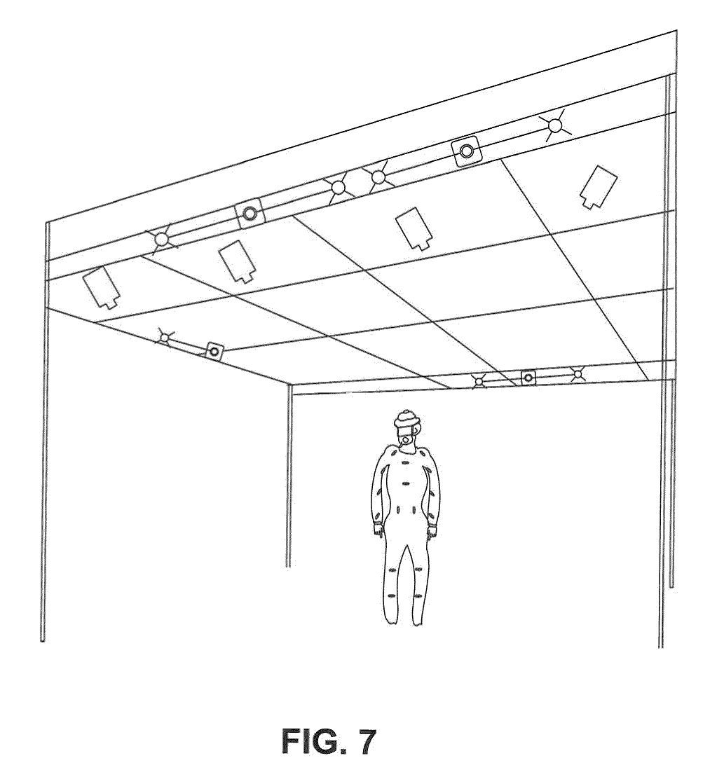

In one implementation, the first person point-of-view shots of an actor are generated with the actor wearing a headset camera 502 and a body suit with multiple motion capture markers 510 attached to the suit, and performing within a physical volume of space 500 as shown in FIG. 5. FIG. 6 shows one example of an actor wearing a headset camera and a body suit with multiple motion capture markers attached to the suit. FIG. 7 shows one example setup of a physical volume of space for performing motion capture sessions.

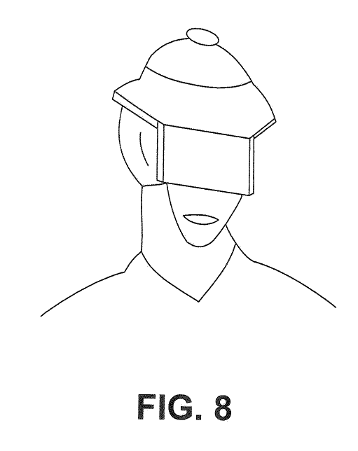

In the illustrated implementation of FIG. 5, the position and orientation of the headset camera 502 worn by the actor 520 is tracked within a physical volume of space 500. The first person point-of-view shots of the actor 520 are then generated by translating the movements of the headset camera 502 into head movements of a person operating within the scenes generated for motion pictures and video games (“3-D virtual environment”). Further, the body movements of the actor 520 are generated by tracking the motion capture markers 510 disposed on a body suit worn by the actor. The scenes generated from the first person point-of-view shots and the body movements of the actor 520 are then fed back to the headset camera 502 worn by the actor to assist the actor to perform within the scenes (e.g., hands and feet of the character operating within the virtual environment are visible). Thus, the feedback allows the actor 520 to see what the character is seeing in the virtual environment and to virtually walk around that environment. The actor 520 can look and interact with characters and objects within the virtual environment. FIG. 8 shows one example of a headset camera, which uses a combination of hardware and software to capture the head movement of an actor.

Referring again to FIG. 5, the position of the headset camera 502 is tracked using position trackers 540 attached to the ceiling. The supports for the trackers 540 are laid out in a grid pattern 530. The trackers 540 can also be used to sense the orientation of the headset camera 502. However, in a typical configuration, accelerometers or gyroscopes attached to the camera 502 are used to sense the orientation of the camera 502.

Once the scenes for the virtual environment are generated, the tracked movements of the headset camera 502 are translated as head movements of a character operating within the virtual environment and the first person point-of-view (i.e., the point of view of the virtual character) shots are calculated and generated. These first person point-of-view shots are provided to a computer for storage, output, and/or other purposes, such as for feeding back to the headset camera 502 to assist the actor 520 to perform within the scenes of the virtual environment. Thus, the process of ‘generating’ the first person point-of-view shots includes: tracking the movements (i.e., the position and orientation) of the headset camera 502 and the movements of the markers 510 on the actor 520 within the physical volume of space 500; translating the movements of the headset camera 502 into head movements of a virtual character corresponding to the actor 520 (i.e., the virtual character is used as an avatar for the actor); translating the movements of the markers 510 into body movements of the virtual character; generating first person point-of-view shots using the head and body movements of the virtual character; and feeding back and displaying the generated to first person point-of-view shots on the headset camera 502.

The generated shots can be fed back and displayed on a display of the headset camera 502 by wire or wirelessly.

In summary, a system for capturing views and movements of an actor performing within virtual scenes generated for motion pictures, video games, and/or simulations is described. The system includes a position tracker, an orientation tracker, a processor, a storage unit, and a display. The position tracker is configured to track the position of a headset camera and a set of motion capture markers. The orientation tracker is configured to track the orientation of the headset camera. The processor includes a storage medium storing a computer program including executable instructions. The executable instructions cause the processor to: translate movements of a headset camera into head movements of a virtual character operating within scenes generated for motion picture or video games, wherein the field of view of the virtual character is generated corresponding to the tracked position and orientation of the physical headset camera; translate movements of motion capture markers into body movements of the virtual character; generate first person point-of-view shots using the head and body movements of the virtual character; and feed back and display the generated first person point-of-view shots on the headset camera.

As described above, captured first person point-of-view shots and movements of the actor performing within motion capture volume enables the virtual character operating within generated virtual scenes to move forward, away from, and around the motion captured (or keyframe animated) characters or objects to create a realistic first person point-of-view of the virtual 3-D environment. For example, FIG. 5 shows the actor 520 wearing a headset camera 502 and performing within the physical volume of space 500. Since the camera 502 is being position tracked by trackers 540 above the ceiling and orientation tracked by sensors attached to the camera 502, those tracked information is transmitted to a processor, and the processor sends back a video representing the point of view and movement of the virtual camera operating within the virtual 3-D environment. This video is stored in the storage unit and displayed on the headset camera 502.

Before the simulation of the headset camera (to capture views and movements of an actor) was made available through various implementations of the present invention described above, motion capture sessions (to produce the generated scenes) involved deciding where the cameras were going to be positioned and directing the motion capture actors (or animated characters) to move accordingly. However, with the availability of the techniques described above, the position and angle of the cameras as well as movements of the actors can be decided after the motion capture session (or animation keyframe session) is completed. Further, since the headset camera simulation session can be performed in real-time, multiple headset camera simulation sessions can be performed and recorded before selecting a particular take that provides best camera movement and angle. The sessions are recorded so that each session can be evaluated and compared with respect to the movement and angle of the camera. In some cases, multiple headset camera simulation sessions can be performed on each of the several different motion capture sessions to select a best combination.

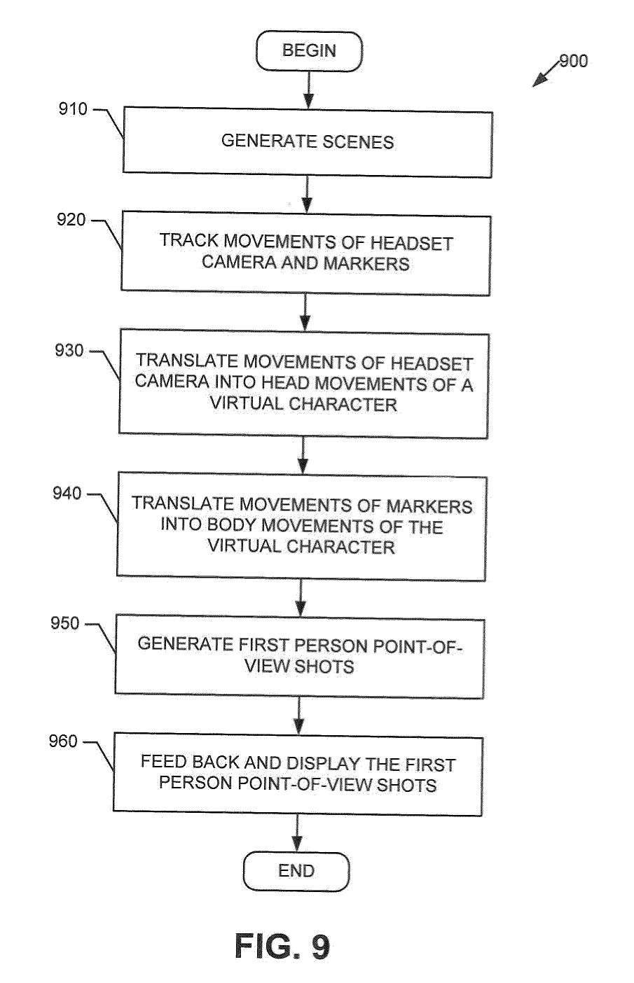

FIG. 9 is a flowchart 900 illustrating a process for capturing views and movements of an actor performing within scenes generated for motion pictures, video games, simulations, and/or other visual entertainment programs in accordance with one implementation. In the illustrated implementation of FIG. 9, the scenes are generated, at box 910. The scenes are generated by capturing them with film cameras or motion capture cameras, processed, and delivered to the headset camera 502. In one implementation, the generated scenes are delivered in a video file including the virtual environment.

At box 920, movements (i.e., the position and orientation) of the headset camera and the markers are tracked within the physical volume of space. As discussed above, in one example implementation, the position of the camera 502 is tracked using position trackers 540 laid out in a grid pattern 530 attached to the ceiling. Trackers 540 or accelerometers/gyroscopes attached to the headset camera 502 can be used to sense the orientation. The physical camera 502 is tracked for position and orientation so that the position and orientation can be properly translated into the head movements (i.e., the field of view) of a virtual character operating within the virtual environment. Therefore, generating scenes for a visual entertainment program comprises performing a motion capture session in which views and movements of an actor performing within the generated scenes are captured. In one implementation, multiple motion capture sessions are performed to select a take that provides best camera movement and angle. In another implementation, the multiple motion capture sessions are recorded so that each session can be evaluated and compared.

The movements of the headset camera 502 are translated into the head movements of the virtual character corresponding to the actor 520, at box 930, and the movements of the markers 510 are translated into body movements of the virtual character (including the movement of the face), at box 940. Thus, translating the movements of the headset camera into head movements of a virtual character to generate the first person point-of-view shots includes translating the movements of the headset camera into changes in the fields of view of the virtual character operating within the virtual environment. The first person point-of-view shots are then generated, at box 950, using the head and body movements of the virtual character. The generated first person point-of-view shots are fed back and displayed on the headset camera 502, at box 960.

In an alternative implementation, the entire camera tracking setup within a physical volume of space is a game in which the player plays the part of a virtual character operating within the game. The setup includes: a processor for coordinating the game; a position tracker that can be mounted on a ceiling; a direction tracker (e.g., accelerometers, gyroscopes, etc.) coupled to the headset camera worn by the player; and a recording device coupled to the processor to record the first person point-of-view shots of the action shot by the player. In one configuration, the processor is a game console such as Sony Playstation®.

The description herein of the disclosed implementations is provided to enable any person skilled in the art to make or use the invention. Numerous modifications to these implementations would be readily apparent to those skilled in the art, and the principals defined herein can be applied to other implementations without departing from the spirit or scope of the invention. For example, although the specification describes capturing views and movements of a headset camera worn by an actor performing within scenes generated for motion pictures and video games, the views and movements of the camera worn by the actor can be operating within other applications such as concerts, parties, shows, and property viewings. In another example, more than one headset camera can be tracked to simulate interactions between the actors wearing the cameras (e.g., two cameras tracked to simulate a fighting scene between two players, where each player has different movement and angle of view). Thus, the invention is not intended to be limited to the implementations shown herein but is to be accorded the widest scope consistent with the principal and novel features disclosed herein.

Various implementations of the invention are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Additionally, the steps of a method or technique described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

1. A method of generating scenes for virtual environment of a visual entertainment program, comprising:
capturing views and movements of an actor performing within the generated scenes, comprising:
tracking movements of a headset camera and a plurality of motion capture markers worn by the actor within a physical volume of space;
translating the movements of the headset camera into head movements of a virtual character operating within the virtual environment;
translating the movements of the plurality of motion capture markers into body movements of the virtual character;
generating first person point-of-view shots using the head and body movements of the virtual character; and
providing the generated first person point-of-view shots to the headset camera worn by the actor.

2. The method of claim 1, wherein the visual entertainment program is a video game.

3. The method of claim 1, wherein the visual entertainment program is a motion picture.

4. The method of claim 1, wherein the movements of the headset camera are tracked by computing positions and orientations of the headset camera.

5. The method of claim 4, wherein the positions of the headset camera are tracked using position trackers positioned within the physical volume of space.

6. The method of claim 4, wherein the orientations of the headset camera are tracked using at least one of accelerometers and gyroscopes attached to the headset camera.

7. The method of claim 1, wherein translating the movements of the headset camera into head movements of a virtual character to generate the first person point-of-view shots comprises
translating the movements of the headset camera into changes in fields of view of the virtual character operating within the virtual environment.

8. The method of claim 1, wherein generating scenes for a visual entertainment program comprises
performing a motion capture session in which views and movements of an actor performing within the generated scenes are captured.

9. The method of claim 8, further comprising
performing multiple motion capture sessions to select a take that provides best camera movement and angle.

10. The method of claim 9, wherein the multiple motion capture sessions are recorded so that each session can be evaluated and compared.

11. The method of claim 1, wherein providing the generated first person point-of-view shots to the headset camera comprises
feeding back the first person point-of-view shots to a display of the headset camera.

12. The method of claim 1, further comprising
storing the generated first person point-of-view shots in a storage unit for a later use.

13. A method of capturing views and movements of an actor performing within generated scenes, comprising:
tracking positions and orientations of an object worn on a head of the actor within a physical volume of space;
tracking positions of motion capture markers worn on a body of the actor within a physical volume of space;
translating the positions and orientations of the object into head movements of a virtual character operating within virtual environment;
translating the positions of the plurality of motion capture markers into body movements of the virtual character; and
generating first person point-of-view shots using the head and body movements of the virtual character.

14. The method of claim 13, further comprising
providing the generated first person point-of-view shots to a display of the object worn on the head of the actor.

15. The method of claim 13, wherein the virtual environment in which the virtual character is operating comprises
virtual environment generated for a video game.

16. The method of claim 13, wherein the virtual environment in which the virtual character is operating comprises
hybrid environment generated for a motion picture in which virtual scenes are integrated with live action scenes.

17. A system of generating scenes for virtual environment of a visual entertainment program, comprising:
a plurality of position trackers configured to track positions of a headset camera object and a plurality of motion capture markers worn by an actor performing within a physical volume of space;
an orientation tracker configured to track orientations of the headset camera object;
a processor including a storage medium storing a computer program comprising executable instructions that cause the processor to:
receive a video file including virtual environment;
receive tracking information about the positions of the headset camera object and the plurality of motion capture markers from the plurality of position trackers;
receive tracking information about the orientations of the headset camera object from the orientation tracker;
translate the positions and the orientations of the headset camera object into head movements of a virtual character operating within the virtual environment;
translate the positions of the plurality of motion capture markers into body movements of the virtual character;
generate first person point-of-view shots using the head and body movements of the virtual character; and
provide the generated first person point-of-view shots to the headset camera object worn by the actor.

18. The system of claim 17, wherein the visual entertainment program is a video game.

19. The system of claim 17, wherein the visual entertainment program is a motion picture.

20. The system of claim 17, wherein the orientation tracker comprises
at least one of accelerometers and gyroscopes attached to the headset camera object.

21. The system of claim 17, wherein the processor including executable instructions that cause the processor to translate the positions and the orientations of the headset camera object into head movements of a virtual character comprises executable instructions that cause the processor to
translate the positions and the orientations of the headset camera object into changes in fields of view of the virtual character operating within the virtual environment.

22. The system of claim 17, further comprising
a storage unit for storing the generated first person point-of-view shots for a later use.

23. The system of claim 17, wherein the processor is a game console configured to receive inputs from the headset camera object, the plurality of position tracker, and the orientation tracker.

24. The system of claim 17, wherein the headset camera object includes a display for displaying the provided first person point-of-view shots.

25. A computer-readable storage medium storing a computer program for generating scenes for virtual environment of a visual entertainment program, the computer program comprising executable instructions that cause a computer to:
receive a video file including virtual environment;
receive tracking information about the positions of the headset camera object and the plurality of motion capture markers from the plurality of position trackers;
receive tracking information about the orientations of the headset camera object from the orientation tracker;
translate the positions and the orientations of the headset camera object into head movements of a virtual character operating within the virtual environment;
translate the positions of the plurality of motion capture markers into body movements of the virtual character;
generate first person point-of-view shots using the head and body movements of the virtual character; and
provide the generated first person point-of-view shots to the headset camera object worn by the actor.

26. The storage medium of claim 25, wherein executable instructions that cause a computer to translate the positions and the orientations of the headset camera object into head movements of a virtual character to generate the first person point-of-view shots comprise executable instructions that cause a computer to
translate the positions and the orientations of the headset camera object into changes in fields of view of the virtual character operating within the virtual environment.

27. The storage medium of claim 25, wherein executable instructions that cause a computer to provide the generated first person point-of-view shots to the headset camera object comprise executable instructions that cause a computer to
feed back the first person point-of-view shots to a display of the headset camera object.

28. The storage medium of claim 25, further comprising executable instructions that cause a computer to
store the generated first person point-of-view shots in a storage unit for a later use.
